(19) United States
(12) Patent Application Publication
(10) Pub. No.: US 2016/0335321 A1
(43) Pub. Date: Nov. 17, 2016

(54) DATABASE MANAGEMENT SYSTEM, COMPUTER, AND DATABASE MANAGEMENT METHOD

(71) Applicants: HITACHI, LTD., Tokyo (JP); THE UNIVERSITY OF TOKYO, Tokyo (JP)

(72) Inventors: Michiko YOSHIDA, Tokyo (JP); Akira SHIMIZU, Tokyo (JP); Shinji FUJIWARA, Tokyo (JP); Kazuhiko MOGI, Tokyo (JP); Kazuo GODA, Tokyo (JP); Masaru KITSUREGAWA, Tokyo (JP)

(21) Appl. No.: 15/111,201

(22) PCT Filed: Mar. 28, 2014
(86) PCT No.: PCT/JP2014/059274

§ 371 Date: Jul. 13, 2016

(51) Int. Cl. G06F 17/30

(52) U.S. Cl. CPC G06F 17/30466; G06F 17/30469; G06F 17/3048

(57) ABSTRACT

A database management system determines whether an exhibition performance, which is a performance exhibited by execution of a query being in execution, satisfies a predetermined condition continuously on and after a certain time point, based on an execution state of the database management system. When the determination result is affirmative and there is an execution-waiting query, the database management system starts execution of the execution-waiting query before execution of the query being in execution ends.

### TECHNICAL FIELD

This invention generally relates to processing of process requests and relates to database management techniques, for example.

### BACKGROUND ART

In enterprise activities, utilization of business data generated in a large amount is indispensable. Thus, a system that analyzes a database that stores a large amount of business data has already been devised. In this analysis process, a database management system (hereinafter a DBMS) receives a query and issues a data read request to a storage apparatus that stores a database (hereinafter a DB). A technique disclosed in PTL 1 is known as a technique of reducing the latency for a data read in execution for one query. According to PTL 1, a DBMS dynamically generates tasks and executes the tasks in parallel whenever reading data necessary for execution of a query to thereby multiplex a data read request. In execution of tasks, a portion of the upper limit of a system performance is exhibited. The “system performance” includes the performance of a computer including the DBMS and may also include the performance of a computer system which includes the computer and other apparatuses.

### CITATION LIST

### Patent Literature

### [PTL 1]

Japanese Patent Application Publication No. 2007-34414

### SUMMARY OF INVENTION

### Technical Problem

Examples of the system performance include a CPU (Central Processing Unit) performance and an I/O performance. According to PTL 1, the DBMS dynamically generates tasks and executes the tasks in parallel whenever executing one query to thereby multiplex a data read request. The CPU performance can be exhibited up to its upper limit by parallel execution of tasks, and the I/O performance can be exhibited up to its upper limit by multiplication of a data read request.

However, the system performance is not always exhibited up to its upper limit in processing of one query.

Such a problem may occur in another computer program or a system such as a computer system that processes the same process request as a query without being limited to the DBMS that processes queries.

### Solution to Problem

A DBMS determines whether an exhibition performance, which is a performance exhibited by execution of a query being in execution, satisfies a predetermined condition continuously on and after a certain time point, based on an execution state of the DBMS. When the determination result is affirmative, and an execution-waiting query is present, the DBMS starts execution of the execution-waiting query before the execution of the query being in execution ends.

### Advantageous Effects of Invention

The system performance can be exhibited up to its upper limit as close as possible.

### BRIEF DESCRIPTION OF DRAWINGS

FIG. 1 illustrates a configuration of a computer system according to Embodiment 1.

FIG. 2 is an example of a first query according to Embodiment 1.

FIG. 3 is an example of a second query according to Embodiment 1.

FIG. 4A illustrates an example of a query execution plan of the first query according to Embodiment 1.

FIG. 4B illustrates an example of query execution plan information according to Embodiment 1.

FIG. 5 illustrates an example of management of an execution state of a DBMS according to Embodiment 1.

FIG. 6 is a flowchart illustrating the flow of query execution start determination according to Embodiment 1.

FIG. 7 is a flowchart illustrating the flow of tail phase determination according to Embodiment 1.

FIG. 8 is a flowchart illustrating the flow of performance margin determination according to Embodiment 1.

FIG. 9 illustrates an example of management of an execution state of a DBMS according to Embodiment 2.

FIG. 10 is a flowchart illustrating the flow of tail phase determination according to Embodiment 2.

FIG. 11 illustrates a configuration of a computer system according to Embodiment 3.

### DESCRIPTION OF EMBODIMENTS

Hereinafter, several examples will be described with reference to the drawings. The issuing source of queries to a database management system (hereinafter a DBMS) may be a computer program in the DBMS or may be an external computer program. For example, the query issuing source may be a computer program (for example, an application program) executed in a database server (hereinafter a DB server) having a DBMS and may be a computer program (for example, an application program) executed by an apparatus such as a client computer coupled to the DB server.

### Embodiment 1

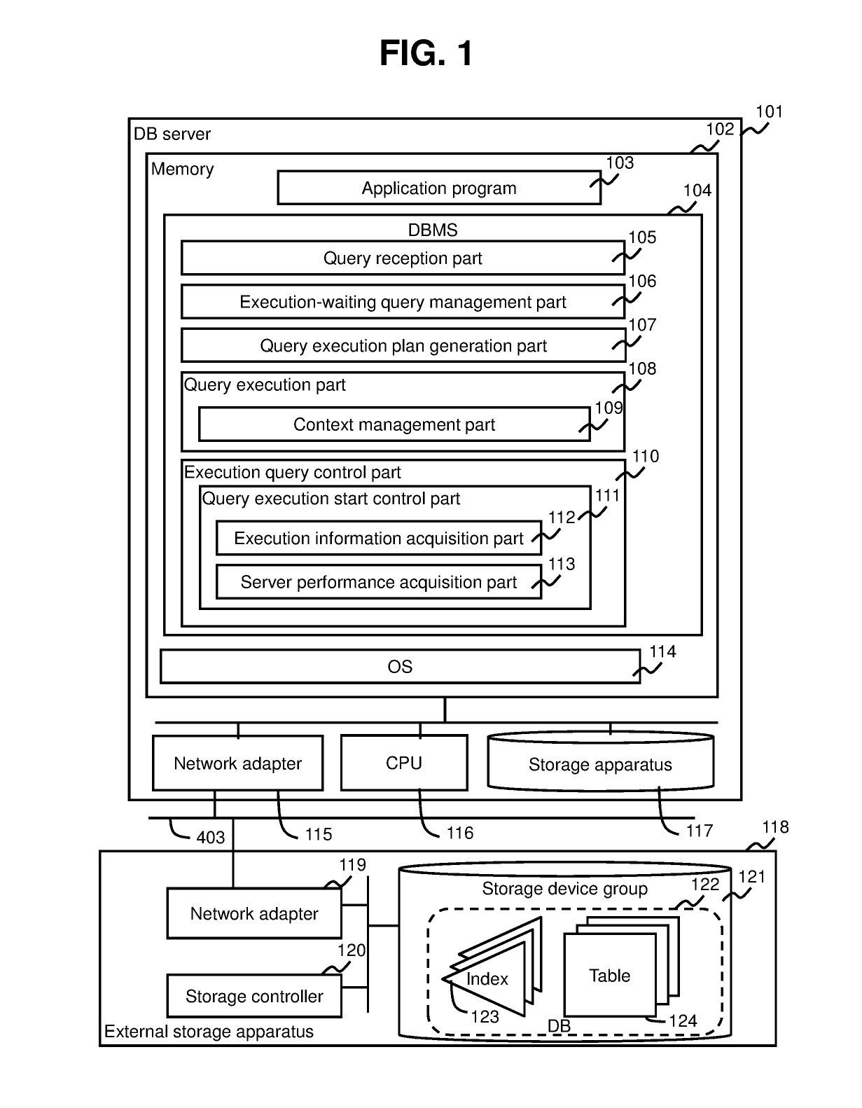

FIG. 1 illustrates a configuration of a computer system according to Embodiment 1.

A DB server 101 is an example of a computer and is a personal computer, a workstation, or a main frame, for example. Alternatively, the DB server 101 may be a virtual computer configured by a virtualization program in these computers. The DB server 101 includes a network adapter 115, a memory 102, a storage apparatus 117, and a CPU 116 coupled to these components. The CPU 116 executes a computer program. The computer program executed by the CPU 116 is an operating system (hereinafter an OS) 114, the DBMS 104, and an application program 103 that issues queries to the DBMS 104, for example. The memory 102 is a volatile DRAM (Dynamic Random-Access Memory) or the like, for example, and temporarily stores programs executed by the CPU 116 and data used by the programs. The storage apparatus 117 is a nonvolatile magnetic disk, a flash memory, or the like, for example, and stores programs and data used by the programs. The network adapter 115 couples a communication network 403 and the DB server 101. The application program 103 may operate on another computer (not illustrated) coupled to the communication network 403 rather than operating on the DB server 101. The CPU 116 may be an example of a processor coupled to the network adapter 115, the memory 102, and the like.

The DB server 101 may include a plurality of at least one of the components of the CPU 116, the memory 102, the storage apparatus 117, and the network adapter 115 in order to enhance performance and redundancy. The DB server 101 may include an input device (not illustrated) such as a keyboard or a pointing device and an output device (not illustrated) such as a liquid crystal display. The input device and the output device (for example, a display device) may be coupled to the CPU 116. The input device and the output device may be integrated.

In the DB server 101, the DBMS 104 executes a query issued from the application program 103 and issues, to the OS 114, an input/output request for input and output of data from and to an external storage apparatus 118 storing a database (hereinafter a DB) 122 in order to read data from the DB 122 or write data to the DB 122 in execution of the query. The OS 114 receives the input/output request and issues an input/output request to the external storage apparatus 118.

The external storage apparatus 118 is an apparatus having a storage device group 121 including a plurality of storage devices. Although the external storage apparatus 118 is a disk array apparatus, for example, the external storage apparatus 118 may be a single storage device. Although the external storage apparatus 118 stores the DB 122, the external storage apparatus 118 may store programs in addition to the data of the DB 122. The external storage apparatus 118 receives an input/output request from the DB server 101, performs data read and write according to the input/output request, and returns the results thereof to the DB server 101.

The external storage apparatus 118 includes the storage device group 121, a network adapter 119, and a storage controller 120 coupled thereto.

The network adapter 119 couples the external storage apparatus 118 to the communication network 403 and is coupled to the DB server 101 via the communication network 403. As a communication protocol via the communication network 403, a fiber channel (FC), an SCSI (Small Computer System Interface), or a TCP/IP (Transmission Control Protocol/Internet Protocol) may be employed. For example, when a fiber channel or a SCSI is employed, the network adapter 115 of the DB server 101 and the network adapter 119 of the external storage apparatus 118 are sometimes referred to as host bus adapters.

The storage device included in the storage device group 121 is a device having a nonvolatile storage medium and is a magnetic disk drive, a flash memory drive, or other semiconductor memory drives, for example. The storage device group 121 may have a RAID (Redundant Array of Independent Disks) mechanism and store data in a predetermined RAID level. A logical storage device (for example, a logical unit, a logical volume, and a file system volume) based on a storage space of the storage device group 121 may be provided to the DB server 101 and the DB 122 may be stored on the logical storage device.

The storage controller 120 includes a memory and a processor, for example, and performs reading or writing of data between the DB server 101 and the storage device group 121 storing the DB 122 according to an input/output request from the DB server 101. For example, upon receiving a data read request from the DB server 101, the storage controller 120 reads data from the storage device group 121 according to the request and returns the read data to the DB server 101.

The external storage apparatus 118 may include a plurality of components such as the storage controller 120 or the like in order to enhance performance and redundancy.

The DBMS 104 manages the DB 122. The DB 122 includes one or more tables 124 and may further include one or more indices 123. The table 124 is a set of one or more records, and a record includes one or more columns. The index 123 is a data structure that is created for one or more columns or the like of the table 124 as a target and is used to accelerate the access to the table 124 based on a selection condition including a target column or the like of the index 123. For example, the table 124 is a data structure that maintains information for specifying a record including the value of the target column, within the table 124 for each value of the target column. A B-tree structure or the like is used as the data structure. A physical address, a logical row ID, or the like may be used as the information for specifying the record.

The DBMS 104 includes a query reception part 105, an execution-waiting query management part 106, a query execution plan generation part 107, a query execution part 108, and an execution query control part 110.

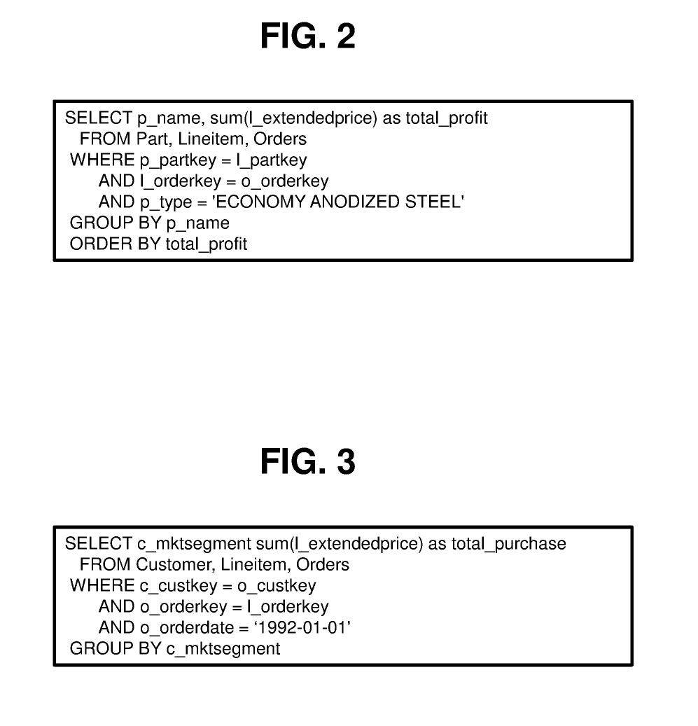

The query reception part 105 receives a query issued by the application program 103. The query is described in SQL, for example. Whenever a query is received, the query reception part 105 informs the execution-waiting query management part 106 of the reception of the query. FIG. 2 illustrates an example of a first query and FIG. 3 illustrates an example of a second query.

The execution-waiting query management part 106 manages whether each of one or more queries received by the query reception part 105 is an execution-waiting query. The “execution-waiting query” is typically an unexecuted query (a query which has not been put into an execution start state even once) and may be a query of which the execution is temporarily suspended in addition to the unexecuted query.

The query execution plan generation part 107 generates a query execution plan including one or more DB operations necessary for executing the query received by the query reception part 105 from the query. The query execution plan is information including one or more DB operations and the relations between the execution orders of the DB operations, for example. The query execution plan is sometimes represented by a tree structure of which the nodes are the DB operations and the edges are the relations between the execution orders of the DB operations. The query execution plan may be generated for a query when the query was received and may be generated for a query when the state of the query changes from an execution waiting state to an execution start state rather than being generated for the query when the query was received.

The query execution part 108 executes a query put into an execution start state by the execution query control part 110 according to the query execution plan generated by the query execution plan generation part 107. The query execution part 108 dynamically generates tasks for executing a DB operation in execution of the query and executes the tasks generated dynamically. When two or more executable tasks are present, the query execution part 108 executes at least two tasks in parallel among these two or more tasks. In this way, it is possible to issue a data read request in a multiplexed manner. The query execution part 108 may be a query execution part to which the technique of PTL 1 is applied. Specifically, the query execution part 108 may perform: (a) generating a task for executing a DB operation; (b) executing the generated task to issue a data read request for reading data necessary for the DB operation corresponding to the task; (c), when it is necessary to execute another DB operation based on an execution result of the DB operation corresponding to the task executed in (b), generating one or more new tasks that executes the other DB operation; and (d) performing (b) and (c) for each of the one or more new tasks. Moreover, the query execution part 108 may execute one or more tasks generated in this way in parallel. When two or more executable tasks are present, the query execution part 108 may execute at least two tasks in parallel among these two or more tasks. The query execution part 108 may execute a plurality of DB operations in one task. Moreover, the query execution part 108 may execute a next DB operation in the same task rather than generating a new task on each occasion. In implementation of tasks, a user thread realized by a library or the like as well as a processor, a kernel thread, and the like realized by the OS 114 may be used, for example.

The query execution part 108 includes a context management part 109. The context management part 109 manages contexts of information indicating the content executed by tasks. For example, the query execution part 108 dynamically generates contexts according to the query execution plan and executes tasks based on the contexts to thereby execute DB operations in the query execution plan. The context management part 109 manages contexts. The context may store information (for example, a page ID) for specifying a page in the storage device group 121 of the external storage apparatus 118 in which a data address set is stored, information indicating an entry to be accessed by a task which starts being executed subsequently among entries stored in the data address set, and a remaining number (number of generatable tasks) of entries accessed by execution of tasks. The context management part 109 may add a context to a management target whenever the context is generated and may remove a context from a management target whenever the context is removed.

The execution query control part 110 determines whether an exhibition performance, which is a performance exhibited when execution of a query being in execution is continued, satisfies a predetermined condition continuously on and after a certain time point, based on an execution state of the DBMS 104. When the determination result is affirmative, and an execution-waiting query is present, the execution query control part 110 starts execution of the execution-waiting query before the execution of the query being in execution ends. Specifically, the execution query control part 110 includes a query execution start control part 111. The query execution start control part 111 determines whether execution of a query is to be started. When the query execution start control part 111 determines that execution of a query is to be started, the execution query control part 110 specifies an execution-waiting query (for example, acquires the execution-waiting query) managed by the execution-waiting query management part 106 and delivers the specified query to the query execution part 108 (for example, delivers the acquired query to the query execution part 108). The query execution start control part 111 includes an execution information acquisition part 112 and a server performance acquisition part 113. The execution information acquisition part 112 and the server performance acquisition part 113 will be described later.

Although the query reception part 105, the execution-waiting query management part 106, the query execution plan generation part 107, the query execution part 108, and the execution query control part 110 are realized when the DBMS 104 is executed by the CPU 116, at least a portion of processes performed by at least one of these components may be realized by hardware. A computer program including the DBMS 104 may be installed in the DB server 101 from a program source. The program source may be a storage medium that can be read by the DB server 101, for example.

The configuration of the DBMS 104 illustrated in FIG. 1 is an example only. For example, a certain component may be divided into a plurality of components, and a plurality of components may be integrated into one component.

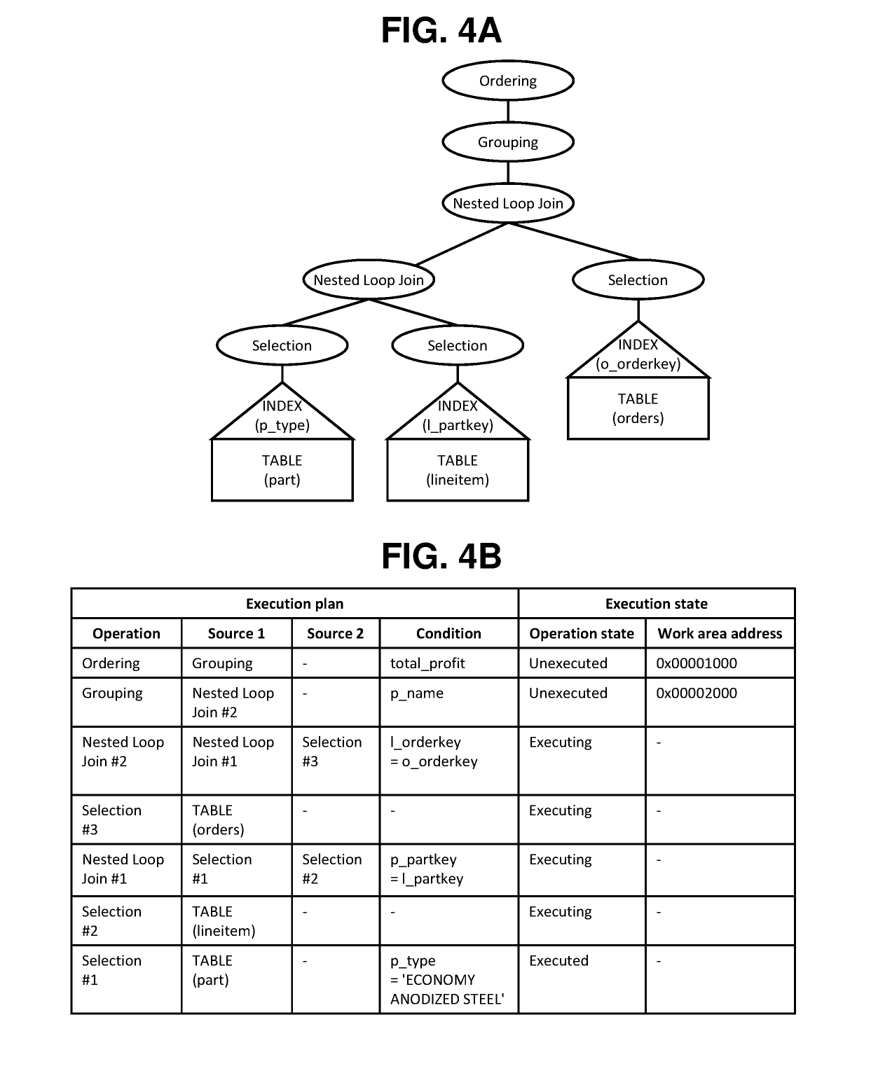

FIG. 4A illustrates an example of a query execution plan of the first query illustrated in FIG. 2.

The query execution plan generation part 107 generates a query execution plan illustrated in FIG. 4A from the first query illustrated in FIG. 2. According to the example of FIG. 4A, two join operations are illustrated. The join operations are nested loop join. Specifically, first nested loop join which uses the extraction result from a Part table as an outer table (join source) and uses the extraction result from a Lineitem table as an inner table (join destination) and second nested loop join which uses the result of the first nested loop join as an outer table and the extraction result from an Orders table as an inner table are illustrated.

First, the query execution part 108 acquires a storage position of a part table record of which p_type is identical to “ECONOMY ANODIZED STEEL” using a p_type index according to the query execution plan of FIG. 4A and reads the part table record stored in the acquired storage position from the part table. Subsequently, the query execution part 108 acquires a storage position of a lineitem table record of which l_partkey is identical to p_partkey of the read part table record using an l_partkey index and reads the lineitem table record stored in the acquired storage position from the lineitem table. Subsequently, the query execution part 108 acquires a storage position of an orders table record of which o_orderkey is identical to l_orderkey of the read lineitem table record using an o_orderkey index and reads the orders table record stored in the acquired storage position from the orders table. Finally, the query execution part 108 joins all read records to sum up a total_profit for each p_name and sorts the generated summation result based on the value of the total_profit.

The query execution plan generation part 107 calculates an estimated join rate for each join operation during generation of the query execution plan and associates the calculated estimated join rate with a corresponding join operation. In a join operation, the “join rate” is a multiplication factor of the number of items of join results in relation to the number of items of join sources. For example, a join rate of 2 indicates that the number of items of join results is two times the number of items of join sources. The “estimated join rate” is an estimated value of the join rate. For example, when the number of items of join results is two times the number of items of join sources, the estimated join rate is estimated to be 2. The estimated join rate may be calculated by a component (for example, the execution information acquisition part 112) other than the query execution plan generation part 107 instead of the query execution plan generation part 107. Moreover, the estimated join rate may be calculated when the query execution plan is generated or when execution of a query starts.

FIG. 4B illustrates an example of query execution plan information.

The query execution plan information is a portion of information included in the DBMS 104. The query execution plan generated by the query execution plan generation part 107 is information including one or more database operations and the relation between the execution orders of database operations and is stored in the query execution plan information as illustrated in FIG. 4A. The query execution plan information includes execution plan information and execution state information. The execution plan information is information indicating the configuration of a query execution plan, and includes, for each DB operation, “Operation” (for example, the name of a DB operation), “Source 1” (an outer table or information indicating a previous-stage DB operation), “Source 2” (an inner table or information indicating another previous-stage DB operation), and “Condition” (information indicating conditions), for example. The execution state information is information indicating an execution state of each DB operation and the address of a reserved work area, and includes, for each DB operation, “Operation State” (information indicating the state (executed, executing, or unexecuted) of a DB operation) and “Work area address” (the address of a reserved work area), for example. From this query execution plan information, it is possible to understand the configuration of a query execution plan and whether a work area has been reserved for a subsequent-stage DB operation.

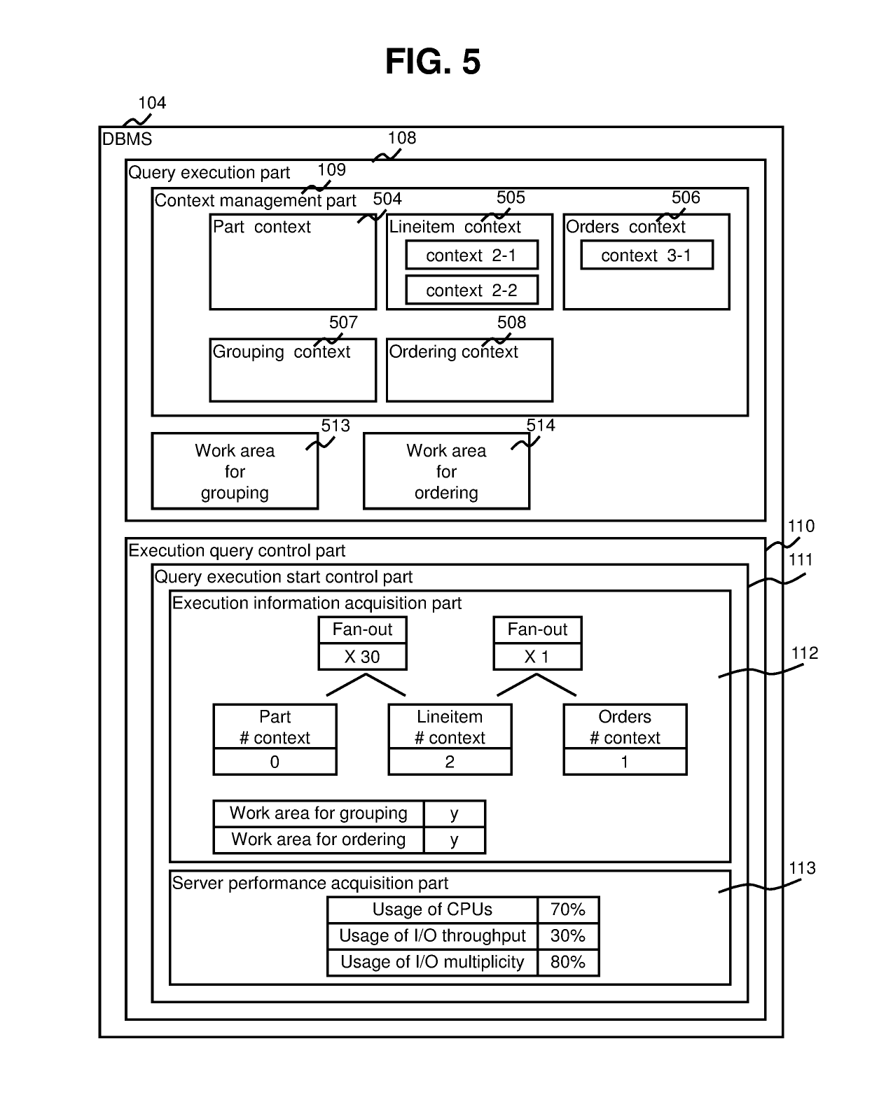

FIG. 5 illustrates an example of management of the execution state of the DBMS 104.

The context management part 109 manages, for each node of the query execution plan, contexts in unexecuted and executing states among the contexts generated when the query execution part 108 processes a query according to the query execution plan. For example, when a query is processed according to the query execution plan of FIG. 4A, the query execution part 108 multiplexes a data read request during reading of the p_type index and the part table. The context management part 109 adds a context including the content of the multiplexed data read request to a part context 504. Moreover, the query execution part 108 multiplexes the data read request during reading of the l_partkey index and the lineitem table, and the context management part 109 adds a context including the content of the multiplexed data read request to a lineitem context 505. Moreover, the query execution part 108 multiplexes the data read request during reading of the o_orderkey index and the orders table, and the context management part 109 adds a context including the content of the multiplexed data read request to an orders context 506. Five boxes indicated by reference numerals 504 to 508 correspond to one DB operation.

The execution information acquisition part 112 acquires query execution information. The query execution information may include an estimated join rate of each join operation, the number of contexts managed for each specific node of the query execution plan, and memory reservation information. The memory reservation information includes at least the execution state information among the items of information illustrated in FIG. 4B, for example. The estimated join rate of each join operation (nested loop join) and the number of contexts managed for each specific node of the query execution plan are acquired through the query execution plan generation part 107, for example. According to the example of FIG. 5, “30” is acquired as an estimated join rate (an estimated join rate between the extraction result of the part table and the extraction result of the lineitem table) of the first join operation, and “1” is acquired as an estimated join rate between the join result and the extraction result of the orders table (in FIG. 5, the estimated join rate is described as “fan-out”). Moreover, according to the example of the execution state illustrated in FIG. 5, “0” is acquired as the number of contexts registered in the part context 504, “2” is acquired as the number of contexts registered in the lineitem context 505, and “1” is acquired as the number of contexts registered in the orders context 506. Moreover, according to the example of the execution state illustrated in FIG. 5, from the acquired memory reservation information, it is possible to understand whether a work area is reserved for each subsequent-stage DB operation and the address of the reserved work area if the work area is reserved. Specifically, from the memory reservation information, it is possible to understand the address of a work area 513 reserved for “Grouping” (summing-up) the subsequent-stage DB operations and the address of a work area 514 reserved for “Ordering” (sorting) the subsequent-stage DB operations.

The server performance acquisition part 113 acquires server performance information using the function provided by the OS 114. The server performance information indicates a server performance (performance index) exhibited by execution of a query being in execution and indicates a CPU performance and an I/O performance, for example. The CPU performance is the usage of CPUs. The I/O performance is the usage of I/O throughput and the usage of I/O multiplicity, for example. The usage of CPUs is the percentage of the amount of CPU resources being used in relation to the amount of allowed CPU resources. The usage of I/O throughput is the percentage of an I/O throughput being used (exhibited) in relation to an allowed I/O throughput (the maximum I/O throughput that can be exhibited). The usage of I/O multiplicity is the percentage of an I/O multiplicity being used (exhibited) in relation to an allowed I/O multiplicity (the I/O multiplicity that can be exhibited). According to the example of the execution state illustrated in FIG. 5, the usage of CPUs is “70%,” the usage of I/O throughput is “30%,” and the usage of I/O multiplicity is “80%.” Various usages (performance indices) may be the percentages of various performance values (values that can be acquired using the function provided by the OS 114) in relation to the upper limit values of various performance values, for example. The upper limit values of various performance values may be acquired using the function provided by the OS 114, may be input from a user through the input device (not illustrated), and may be acquired from a management computer (not illustrated) or the like via the network adapter 115.

The query execution start control part 111 repeatedly (for example, periodically) acquires query execution information with the aid of the execution information acquisition part 112, acquires server performance information with the aid of the server performance acquisition part 113, and determines whether an execution-waiting query is to be executed based on the acquired query execution information and server performance information.

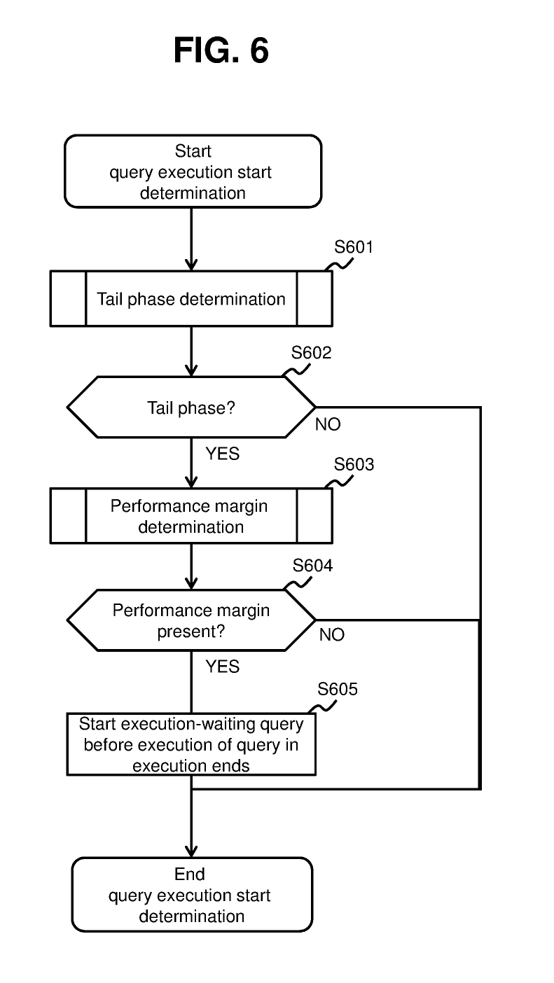

FIG. 6 is a flowchart illustrating the flow of query execution start determination. The query execution start determination may be performed repeatedly (for example, periodically).

The query execution start control part 111 acquires the query execution information with the aid of the execution information acquisition part 112 and determines whether a query being in execution is in a tail phase based on the acquired query execution information (S601). The “tail phase” is a phase in which the performance exhibited by execution of a query being in execution decreases for the query being in execution in a period between a determination time point of S601 and an ending time point of the query being in execution (that is, the tail phase is a phase in which a performance value corresponding to at least one performance index among the usage of CPUs, the usage of I/O throughput, the I/O multiplicity, and the memory usage is lower than a performance value at the determination time point of S601).

When the determination result of S601 indicates that the query being in execution is not in a tail phase (S602: NO), the query execution start control part 111 ends the query execution start determination.

When the determination result of S601 indicates that the query being in execution is in a tail phase (S602: YES), the query execution start control part 111 acquires server performance information with the aid of server performance acquisition part 113 and determines whether there is a margin in a server performance based on the acquired server performance information (S603). When the determination result of S603 indicates that there is no performance margin (S604: NO), the query execution start control part 111 ends query execution start determination.

When the determination result of S603 indicates that there is a performance margin (S604: YES), the query execution start control part 111 puts the execution-waiting query into an execution start state before execution of the query being in execution ends. The query put into the execution start state is processed by the query execution part 108.

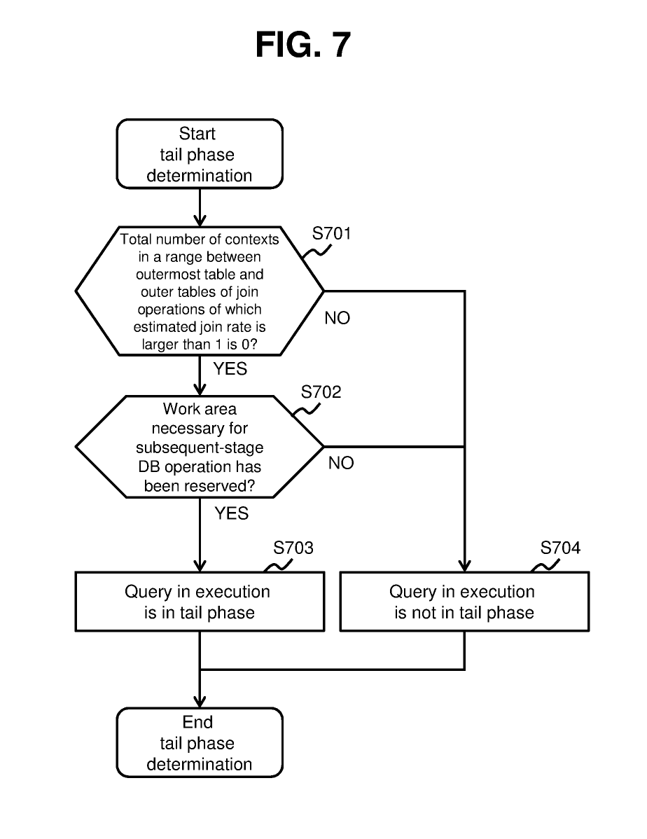

FIG. 7 is a flowchart illustrating the flow of tail phase determination (S601 in FIG. 6).

The query execution start control part 111 determines whether a total number of contexts in unexecuted and executing states in a range between the outermost table and the outer tables of join operations of which the estimated join rate is larger than 1 is 0 based on the query execution information (particularly, the configuration of a query execution plan, the progress of the query execution plan, and the estimated join rate of each join operation) (S701). The fact that “total number of contexts in unexecuted and executing states in a range between the outermost table and the outer tables of join operations of which the estimated join rate is larger than 1 is 0” means that the multiplicity of a task (data read request) has not increased from the multiplicity at the determination time point of S701. If the estimated join rate is larger than 1, the number of join sources of a join operation is larger than the number of join results and the multiplicity when executing such subsequent processes in a multiplexed manner also increases. In such a case, when the execution-waiting query is put into an execution start state, a performance surplus (in other words, a resource shortage) may occur due to an increase in the performance resulting from execution of a new query put into an execution start state and an increase in the performance for a query being in execution. The determination of S701 is effective in avoiding this from occurring.

When the determination result of S701 is false (S701: NO), the query execution start control part 111 outputs information indicating that the query being in execution is not in the tail phase as the result of the tail phase determination (S704).

When the determination result of S701 is affirmative (S701: YES), the query execution start control part 111 determines whether a work area necessary for a subsequent-stage DB operation (an unexecuted DB operation) has been reserved based on the query execution information (particularly, the configuration of the query execution plan, the progress of the query execution plan, and the memory reservation information) (S702). This is because, if a work area necessary for the subsequent-stage DB operation is not reserved, there is a possibility that the memory usage may increase from that at the determination time point of S702 when such a work area is reserved. Thus, when the determination result of S702 is false (S702: NO), the query execution start control part 111 outputs information indicating that the query being in execution is not in the tail phase as the result of the tail phase determination (S704).

When the determination result of S702 is affirmative (S702: YES), the query execution start control part 111 outputs information indicating that the query being in execution is in the tail phase as the result of the tail phase determination (S703).

Such tail phase determination is particularly effective in such a case as in PTL 1, for example, in which the query execution part 108 dynamically generates tasks for executing a DB operation in execution of a query, executes the tasks generated dynamically, and, when two or more executable tasks are present, executes at least two tasks in parallel among the two or more tasks.

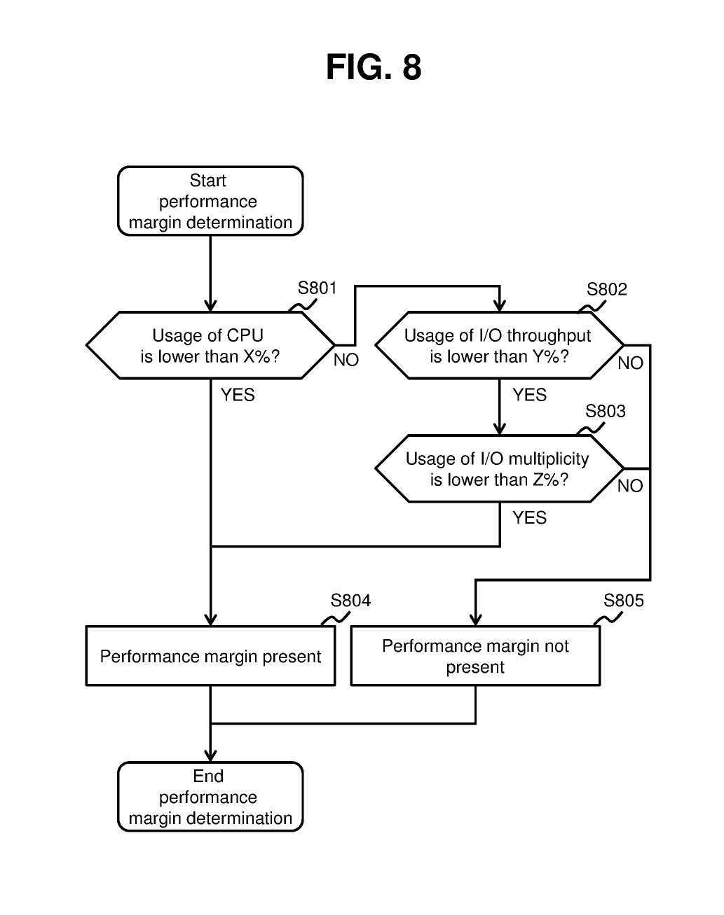

FIG. 8 is a flowchart illustrating the flow of performance margin determination (S603 in FIG. 6).

The query execution start control part 111 determines whether the usage of CPUs in the server performance information is lower than X % (X=upper limit of the usage of CPUs) (S801).

When the determination result of S801 is affirmative (S801: YES), the query execution start control part 111 outputs information indicating that there is a performance margin as the result of performance margin determination (S804).

When the determination result of S801 is false (S801: NO), the query execution start control part 111 determines whether the usage of I/O throughput in the server performance information is lower than Y % (Y=upper limit of the usage of I/O throughput) (S802). When the determination result of S802 is affirmative (S802: YES), the query execution start control part 111 further determines whether the usage of I/O multiplicity in the server performance information is lower than Z % (Z=upper limit of the usage of I/O multiplicity) (S803).

When the determination result of S803 is affirmative (S803: YES), the query execution start control part 111 outputs information indicating that there is a performance margin as the result of performance margin determination (S804).

When the determination result of S802 or S803 is false (S802: NO or S803: NO), the query execution start control part 111 outputs information indicating that there is no performance margin as the result of performance margin determination (S805).

According to Embodiment 1, both the tail phase determination and the performance margin determination are performed based on the query execution information. When the results of both determinations are affirmative, an execution-waiting query is put into an execution start state before execution of a query being in execution ends. When the query being in execution is in the tail phase and the server performance has not reached its upper limit, the execution-waiting query starts before execution of the query being in execution ends. Thus, it can be expected that the server performance can be exhibited up to its upper limit as close as possible.

Hereinabove, Embodiment 1 has been described. The performance margin being present may mean that both the CPU performance and the I/O performance have not reached their upper limits. Moreover, the server performance (performance index) may include another performance (performance index) (for example, a memory performance (for example, a memory usage)) instead of or in addition to at least one of the CPU performance and the I/O performance. Moreover, the expression that the exhibited server performance has reached its upper limit (the server performance is lower than the upper limit) may be rephrased as an expression that the amount of system resources used has reached its upper limit (the amount of system resources is lower than the upper limit). The system resources include the resources of the DB server 101 and may be the resources of a computer system including an apparatus (for example, the external storage apparatus 118) different from the DB 110. At least one of the usage of CPUs, the usage of I/O throughput, and the usage of I/O multiplicity, for example, may be employed as the system resources.

### Embodiment 2

Embodiment 2 will be described below. Difference features from Embodiment 1 will be described mainly, and the description of the same features as those of Embodiment 1 will not be provided or may be simplified.

Depending on a query (a query execution plan), a DB operation which cannot execute tasks in parallel may be present. For example, a sort process of search result sets is an example of such a DB operation. Although tasks can be executed in parallel in a partial portion of the sort process, tasks cannot be executed in parallel in the entire sort process.

Thus, in the tail phase determination of Embodiment 2, it is determined whether execution of all DB operations in which tasks can be executed in a multiplexed manner has ended, and the determination result thereof affects determination on whether a task in execution is in a tail phase.

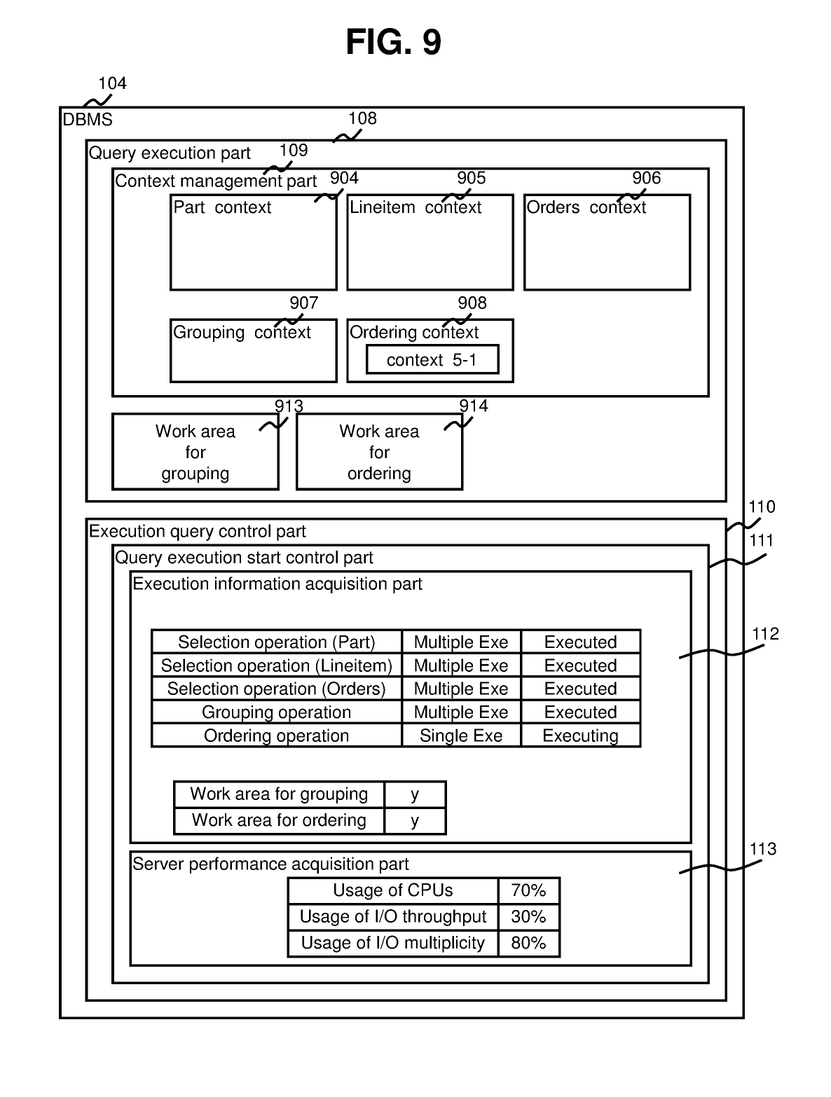

FIG. 9 illustrates an example of management of an execution state of the DBMS 104 according to Embodiment 2.

The query execution information that the execution information acquisition part 112 acquires from the query execution part (108) includes the number of contexts managed for each node of the query execution plan and the memory reservation information. The execution information acquisition part 112 determines whether each node (DB operation) is in an Unexecuted, Executing, or Executed state based on the number of contexts of each node in the query execution information. According to the example of the execution state illustrated in FIG. 9, since the number of contexts registered in a part context 904, a lineitem context 905, and an orders context 906 is 0, a Selection operation (Part), a Selection operation (Lineitem), and a Selection operation (Orders) are determined to be in the Executed state. Moreover, since the number of contexts registered in a Grouping context 907 is 0, a Grouping Operation is also determined to be in the Executed state. Moreover, since the number of contexts registered in an Ordering context 908 is 1, an Ordering Operation is determined to be in the Executing state. When the number of contexts corresponding to a DB operation immediately before the DB operation is 1 or more, the DB operation is determined to be in the unexecuted or executing state. Moreover, the query execution start control part 111 acquires information on whether tasks can be executed in a multiplexed manner for each DB operation based on the query execution plan information included in the query execution information, manages DB operations which can be executed in a multiplexed manner as “Multiple Exe”, and manages DB operations which cannot be executed in a multiplexed manner as “Single Exe”.

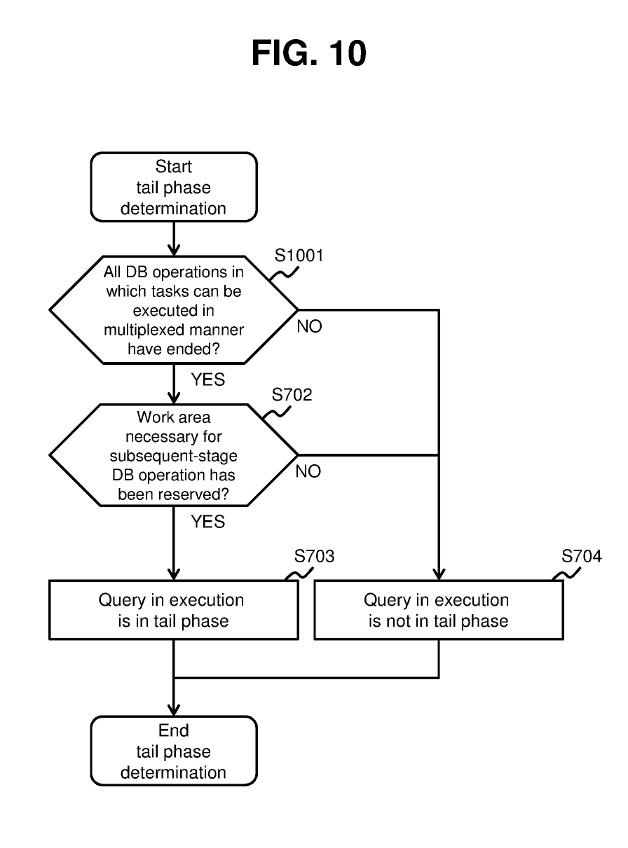

FIG. 10 is a flowchart illustrating the flow of tail phase determination according to Embodiment 2.

In the tail phase determination according to Embodiment 2, S1001 is performed instead of S701 of FIG. 7, and the other steps are the same as those of FIG. 7. In S1001, the query execution start control part 111 determines whether all DB operations in which tasks can be executed in a multiplexed manner have ended based on the query execution information (particularly, the state of each node (DB operation) specified by the execution information acquisition part 112). When the determination result of S1001 is affirmative (S1001: YES), S702 is performed. When the determination result of S1001 is false (S1001: NO), S704 is performed.

When all DB operations which can be executed in a multiplexed manner have ended, the performance exhibited by execution of a query being in execution will not increase (in other words, the amount of resources consumed will not increase). According to Embodiment 2, when it is determined that all DB operations which can be executed in a multiplexed manner have ended and a work area necessary for a subsequent-stage DB operation is reserved, it is determined that the query being in execution is in the tail phase.

### Embodiment 3

Embodiment 3 will be described below. Difference features from Embodiments 1 and 2 will be described mainly, and the description of the same features as those of Embodiments 1 and 2 will not be provided or may be simplified.

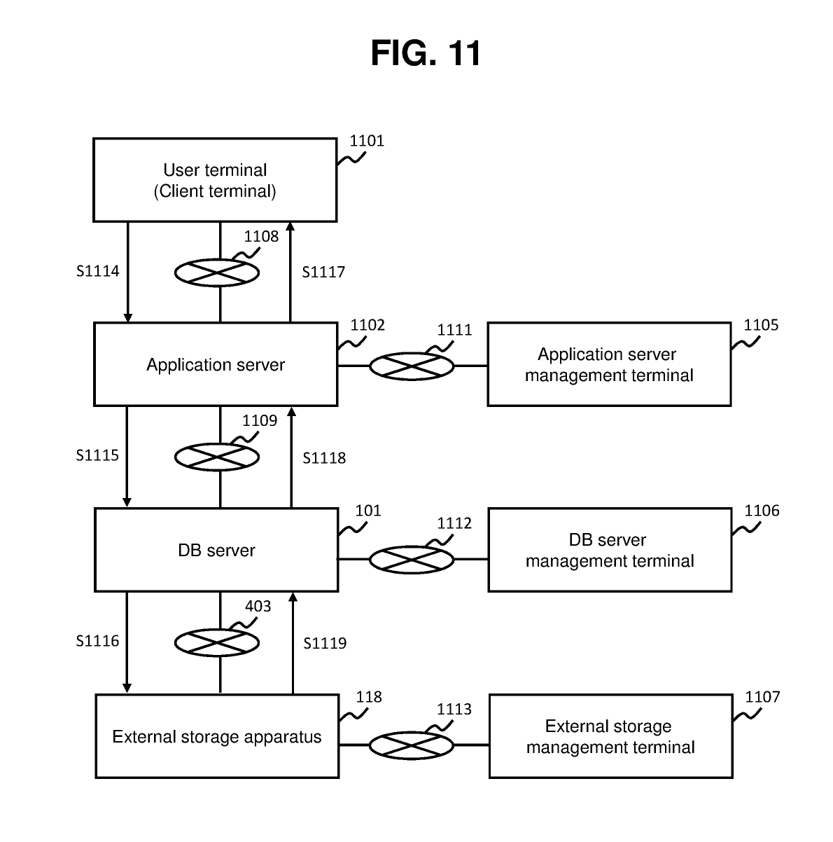

FIG. 11 illustrates the configuration of a computer system according to Embodiment 3.

An application server 1102 is communicably coupled to the DB server 101 via a communication network 1109. Moreover, the DB server 101 is communicably coupled to the external storage apparatus 118 via the communication network 403. A user terminal (client terminal) 1101 is communicably coupled to the application server 1102 via a communication network 1108. The DB server 101 executes the DBMS 104 that manages the DB 122. The external storage apparatus 118 stores the DB 122. The application server 1102 executes an application program that issues a query to the DBMS 104. The user terminal 1101 issues a request to the application program executed by the application server 1102. A plurality of user terminals 1101 or a plurality of application servers 1102 may be present.

An application server management terminal 1105 is communicably coupled to the application server 1102 via a communication network 1111. A DB server management terminal 1106 is communicably coupled to the DB server 101 via a communication network 1112. An external storage management terminal 1107 is communicably coupled to the external storage apparatus 118 via a communication network 1113. The application server management terminal 1105 is a terminal that manages the application server 1102. The DB server management terminal 1106 is a terminal that manages the DB server 101. The external storage management terminal 1107 is a terminal that manages the external storage apparatus 118. At least two of the management terminals 1105 to 1107 may be shared (integrated). Moreover, at least two of the communication networks 403 and 1108 to 1113 may be shared (integrated).

In Embodiment 3, processes are executed in the following manner, for example.

### (S1114)

The user terminal 1101 issues a request (hereinafter, a user request) to the application server 1102.

### (S1115)

The application server 1102 generates a query according to the user request received in S1114. Moreover, the application server 1102 issues the generated query to the DB server 101.

### (S1116)

The DB server 101 receives the query from the application server 1102 and executes the received query. The DB server 101 issues an input/output request (for example, a data read request) for data necessary for execution of the received query to the external storage apparatus 118. The DB server 101 sometimes issues a plurality of data input/output requests in parallel in execution of one query. Thus, the DB server 101 sometimes issues the request of S1116 a plurality of times in parallel in execution of one query.

### (S1119)

The external storage apparatus 118 sends a response to the DB server 101 with respect to the data input/output request issued in S1116. The external storage apparatus 118 sometimes sends the response of S1119 a plurality of times in parallel.

### (S1118)

The DB server 101 generates a query execution result and transmits the query execution result to the application server 1102.

### (S1117)

The application server 1102 receives the query execution result. Moreover, the application server 1102 transmits a reply to the user request received in S1114, pursuant to the execution result to the user terminal 1101.

A plurality of user requests may be simultaneously issued to the application server 1102 or a plurality of queries may be simultaneously issued to the DB server.

While several Embodiments have been described, the present invention is not limited to these Embodiments but can be modified in various forms without departing from the spirit thereof. For example, the present invention can be applied to a system (for example, a file system) other than the DBMS. A computer (or a computer system that includes the computer) that executes such a system may include an execution process request control part that controls the start of execution of each of a plurality of process requests and a request execution part that executes a process request put into an execution start state. The execution process request control part may determine whether an exhibition performance, which is a performance exhibited by execution of a process request being in execution, satisfies a predetermined condition continuously on and after a certain time point based on an execution state of a computer (or a computer system), and when the determination result is affirmative, may put a process request in an execution waiting state into an execution start state before execution of the process request in execution ends. In this manner, in a system other than the DBMS, in the above description, a DB operation may be read an operation and a query may be read a process request.

### REFERENCE SIGNS LIST

104 Database management system (DBMS)

1. A database management system comprising:
an execution query control part configured to control the start of execution of each of a plurality of queries to a database; and
a query execution part configured to execute a query that is put into an execution start state,
the execution query control part configured to
determine whether an exhibition performance which is a performance exhibited by execution of a query being in execution satisfies a predetermined condition continuously on and after a certain time point, based on an execution state of the database management system, and
when the determination result is affirmative, put an execution-waiting query into an execution start state before execution of the query being in execution ends.

2. The database management system according to claim 1, wherein the exhibition performance satisfying the predetermined condition means that the exhibition performance is lower than a predetermined threshold with respect to a system performance including the performance of a computer that includes the database management system.

3. The database management system according to claim 1, wherein
the execution state of the database management system includes an execution query state which is a state of execution of the query being in execution, and
the exhibition performance satisfying the predetermined condition continuously on and after the certain time point means that the exhibition performance is lower than a predetermined threshold with respect to a system performance including the performance of a computer that includes the database management system and the execution query state indicates that the query being in execution is in a tail phase.

4. The database management system according to claim 3, further comprising:
a query execution plan generation part configured to generate for each of the plurality of queries a query execution plan including information indicating a plurality of database operations necessary for executing a query and an execution order of the plurality of database operations,
wherein the execution query state is based on the query execution plan of the query being in execution and the progress of the query being in execution.

5. The database management system according to claim 3, wherein
the plurality of database operations include one or more join operations,
each of the one or more join operations is a database operation of generating a result of record acquired from an inner table using the record acquired from an outer table,
the execution query state further includes a reservation state of a memory area,
the query execution part dynamically generates tasks for executing the database operations in execution of each of the plurality of queries and executes the tasks generated dynamically,
when two or more executable tasks are present, the query execution part, by executing at least two tasks in parallel among these two or more tasks to multiplex, issues a data read request and maintains a context including the content of the multiplexed data read request,
the query in execution being in the tail phase means that a total number of contexts corresponding to database operations in a range between an outermost table and outer tables of join operations, of which an estimated join rate is larger than 1, is 0 and a memory area necessary for a subsequent-stage database operations of the query being in execution is reserved, and
for each join operation, the estimated join rate is an estimated value of a multiplication factor of the number of items of join results in relation to the number of items of join sources.

6. The database management system according to claim 3, wherein the query in execution being in the tail phase means that all database operations, in which two or more tasks are executed in parallel, have been executed.

7. The database management system according to claim 1, wherein the exhibition performance satisfying the predetermined condition means at least one of that a CPU performance satisfies a first condition and that an I/O performance satisfies a second condition.

8. The database management system according to claim 7, wherein
the CPU performance is a usage of CPUs,
the I/O performance is an I/O throughput and an I/O multiplicity,
the CPU performance satisfying the first condition means that the usage of CPUs is lower than a predetermined usage, and
the I/O performance satisfying the second condition means that the I/O throughput is lower than a predetermined throughput and the I/O multiplicity is lower than a predetermined multiplicity.

9. The database management system according to claim 1, wherein the continuously on and after the certain time point means a period between the certain time point and the end of execution of the query.

10. The database management system according to claim 1, wherein the determination on whether the exhibition performance satisfies the predetermined condition continuously on and after the certain time point is performed periodically.

11. A computer comprising:
a memory configured to store information indicating an execution state of a database management system; and
a processor configured to control the start of execution of each of a plurality of queries to a database and execute a query that is put into an execution start state,
the processor configured to
determine whether an exhibition performance, which is a performance exhibited by execution of a query being in execution, satisfies a predetermined condition continuously on and after a certain time point, based on the information, and
when the determination result is affirmative, put an execution-waiting query into an execution start state before execution of the query being in execution ends.

12. A database management method comprising:
determining whether an exhibition performance, which is a performance exhibited by execution of a query being in execution, satisfies a predetermined condition continuously on and after a certain time point, based on an execution state of a database management system, and
starting execution of an execution-waiting query before execution of the query being in execution ends when the determination result is affirmative and there is the execution-waiting query.
